(19) United States
(12) Patent Application Publication
(10) Pub. No.: US 2006/0176570 A1
(43) Pub. Date: Aug. 10, 2006

(54) Substantially toroidal reflective surface element suitable for applying a contact lens to an eye

(76) Inventor: William Hennegan, Fenham (GB)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/513,960

(22) PCT Filed: May 12, 2003
(86) PCT No.: PCT/GB03/02000

§ 371 Date: Jul. 29, 2005

(30) Foreign Application Priority Data
May 10, 2002 (GB) 0210846.2

(51) Int. Cl. G02B 3/00; G02B 25/00

(52) U.S. Cl. 359/642

(57) ABSTRACT

A toroidal reflecting surface that has radii within specified ranges allows the user to view a magnified image of one eye by using the other eye. The image of the eye is seen from the side so that a contact lens or other device can be offered towards the viewed eye without obstructing the view. Illumination devices are provided to highlight the viewed eye and to assist the viewing eye to focus on the other eye. A headrest support is provided to help the user to place the eyes at the correct distance from the toroidal reflective surface.

The present invention relates to an optical imaging element, devised to reflect a focused and perpendicularly reflected image of an object from a concave surface to one eye of the user from a radially displaced position, and more specifically to reflect the optical system of an eye perpendicularly reflected to the opposite eye.

For the sake of brevity the following description will exclusively use the male pronoun, but this could equally be read as female.

Many people wear contact lenses both for aesthetic reasons and for a variety of sporting activities.

However, many users (and many of the spectacle-wearing public) find contact lenses difficult to insert and remove when using flat plane mirrors. Mirrors and enlarging mirrors, as are available, are of little use visually to both eyes when anything is placed in front of the pupil of one eye, such as the finger holding the contact lens.

What is needed is a concave reflective element that can magnify an object close up and reflect it off-axis at various angles including a right angle, such that the image can be viewed in focus at an equal distance from the axis point of the reflective surface where it intersects the axis of the said one eye thereby the problem is alleviated The object of the present invention is to provide such a reflective element. More particularly, the object is to provide such a means to assist the user to see into the interceded area of his eye during the process of inserting and removing a contact lens from the cornea of his eye without the finger holding the contact lens obstructing his view. Still more particularly, the object is to provide such a means to enable the user to position his eyes very close to a reflective surface; and therein, to see a highly magnified close-up of his other eye and then to proceed with the manipulation of a contact lens to the said other eye without the reflective surface obstructing the space required for the manipulation of the contact lens.

I will from herein refer to one eye as the “intended eye” as this will be the eye the user intends to insert and remove a contact lens from, and refer to the other eye as the “viewing eye”.

The present invention stems from the discovery that a magnifying mirror of a specific nature can be used in a specific manner to see a focused close-up of one's intended eye by the viewing eye, to see an image of the optical system of the intended eye at an appropriately wide angle, at an appropriate magnification, and at an appropriate distance from the mirror to serve as a visual aid for the application and removal of a contact lens from the cornea of one's intended eye.

The limited range optical imaging element comprises a reflective surface, which is substantially part of a generally toroidal surface. The reflective surface, as such, has no focal point and is, therefore, limited in its range of image reflection The intended eye image is reflected from a radially displaced position and is presented to the viewing eye of the user in an on-axis view. The reflective surface has to be substantially part of a toroidal surface such that every part of the two cross axis curvatures are at right angles to each other in order for the image to be m in focus from any axis point on the reflective surface. The reflective surface is defined by care choosing two cross axis radii which correspond with each other to form an image of the intended eye which is reflected off-axis to the viewing eye and which is selected from a range of radii in which the average radius of its maximum curvature is between 70 mm and 120 mm and where the average radius of its minimum curvature is between 130 mm and 180 mm.

The reflective surface is of solid construction and the cross-axis radii have, therefore, to be pre-selected before construction. In use, the reflective surface is held in front of the user's eyes with the mini curvature axis in a horizontal position to the user's eyes. The preferred ret curvature radius is 155 mm and the preferred maximum curvature radius is 95 mm. The range of minimum curvature radii may suggest that the mirror could be held far away from the eyes and that the user could still see the eye in focus. However, this is not so, regardless of what combination of radii are chosen from the range of radii above, the farthest distance the mirror can be held from the eyes and still see the image in focus is approximately 80 mm. In order to move the mirror slightly away from the eyes the maximum curvature radius may be increased and the minimum curvature radius decreased accordingly. This moves the mirror away from the eyes in a straight line and keeps the mirror in alignment with the off-axis angle between both eyes. Moving the mirror away from the eyes in the manner described may be more suitable for a person with large facial features. However, when moving the mirror away from the eyes in the manner described it gradually becomes more difficult to see into the intercepted area of the intended eye when the finger holding the contact lens is held close to and in front of the pupil of the intended eye. Similarly, in order to enlarge the magnification of the intended eye, as seen by the viewing eye, the maximum curvature radius may be decreased and the minimum curvature radius increased accordingly. However, as the mirror is moved towards the eyes in the manner described, it gradually becomes more difficult for the user to manoeuvre his head in order to see the intended eye from different positions. Therefore, optimum focusing of the intended eye, as seen by the viewing eye, and optimum close up viewing of the intend eye by the viewing eye can best be served when the average radius of its maximum curvature is be 90 mm and 110 mm and when the average radius of its minimum curvature is between 150 mm and 170 mm and when the difference between its maximum curvature radius and its minimum curvature radius is been 50 mm and 70 mm, for the eye to eye radial spacing of the axis point between both eyes. The mirror can be mounted in a device with its minimum curvature fixed in a horizontal position to the user's eyes. It is a feature of the invention that when the user brings his eyes close to the mirror, then by turning his head slightly to one side and placing one eye (i.e. the viewing eye) in front of the mirror and appropriately adjusting the position of his viewing eye relative thereto, he will see with his viewing eye a focused off-axis magnified image of his intended eye, the visual direction of which will be seen facing sideways. This enables the user to see between his finger and his intended eye while the finger holding the contact lens is held close to and in front of the pupil of the intended eye. This is because the mirror covers the viewing eye and reflects an off-axis close-up of the intended eye. The eyes can be placed in a position quite close to the mirror and thereby see a finely detailed magnified image of the intended eye without obstructing the room required for the manipulation of the contact lens. This unique benefit for the user, is attainable only with a toroidal reflective concave surface utilising the specific range of curvature radii substantially as above outlined. When a device is used in the prescribed manner the mirror reflects an off-axis image of the intended eye which is seen by the viewing eye as a semi-transparent image which varies in inanity by the amount and direction of incident light that falls on the retina of the intended eye. However, the variation and direction of available light that falls on the retina of the intended eye enables the intended eye to see forward and beyond the mirror and the mirror reflects an image of the intended eye which is seen by the viewing eye as a semi-transparent image, thus, making the device harder to use in low ambient light conditions. It is a preferable feature of the invention that light-emitting diodes are placed in a position on each side of the device so that when the device is used in the prescribed manner, each light alternately shines at a precise angle to the visual direction of each intended eye. This creates an effect of enabling the viewing eye to see a real image (as opposed to a semi-transparent image) of the intended eye while simultaneously obstructing the vision of the intended eye. The position of the lights are essential in that, as well as dilating the pupil of the intended eye, they eliminate confusing shadows and dazzling of the intended eye.

The invention will now be described more fully when used in a device, by way of example, and with referee to the accompanying drawings in which:

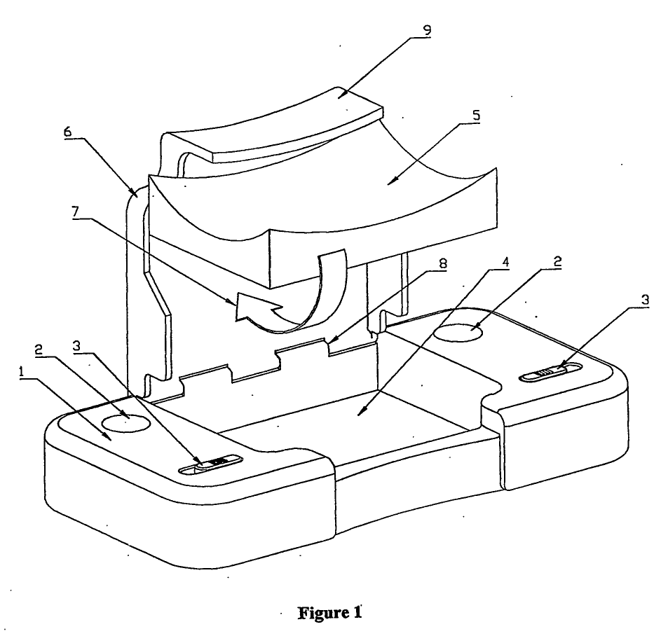

FIG. 1 is a perspective view of the device in accordance with the invention and wherein the device is in an open and usable position.

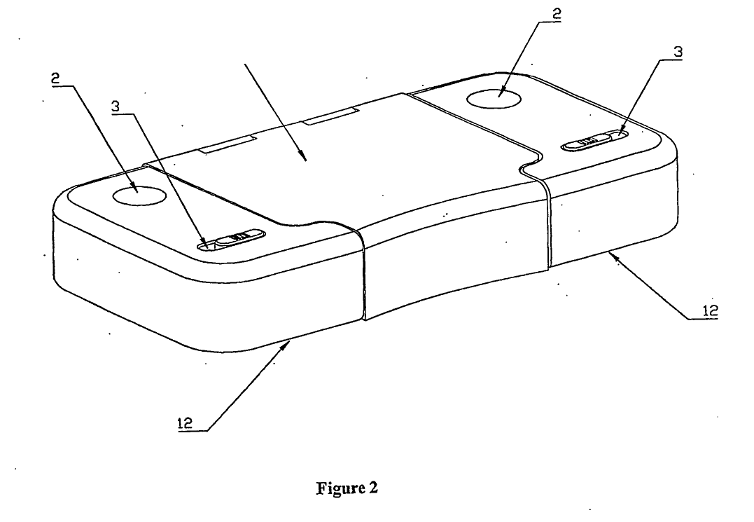

FIG. 2 is a perspective view of the device of FIG. 1 with the device in a closed position (the mirror apparatus being folded inside).

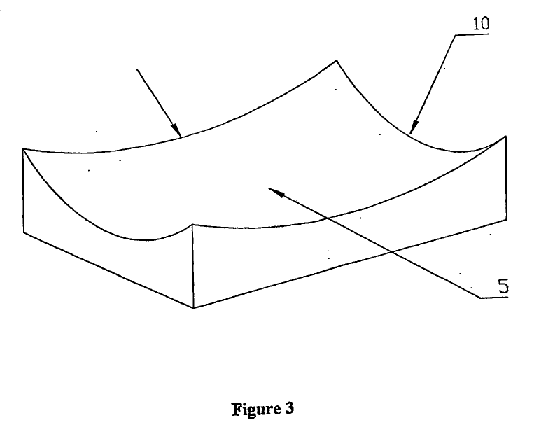

FIG. 3 is a perspective view of the toroidal mirror dimensionally displayed when in use in the device of FIG. 1 and FIG. 2.

The illustrative embodiment of the invention, herein shown, comprises a shallow oblong-shaped box-like structure 1 which is about 150 mm in width and about 18 mm deep containing two LED lights 2 and two light switches 3. In the centre of box 1 is a cavity 4 which contains the mirror 5 when the device is in the closed position The mirror 5 is suspended above the box 1 and is attached to the inner top side of the lid 6 by a spring-loaded hinge (not shown) which enables the mirror 5 to be tucked into the lid 6 prior to closing, and enabling the mirror to spring up again to the horizontal when opened. Arrow 7 indicates the direction that the mirror 5 hinges downwards against spring load prior to the lid 6 being closed. The lid 6 contains two spring-loaded hinges 8 of which one holds the mirror 5 in a horizontal position (not shown) and one that holds the lid 6 in an upright position. The lid also contains a pad 9 upon which the user places his forehead. This places the users bead at the correct focusing distance from the mirror.

FIG. 3 shows the toroidal mirror 5 alone (as used in this embodiment). The mirror has a range of radii in which its maximum curvature radius 10 is between 70 mm and 120 mm and where its minimum curvature radius 11 is between 130 mm and 180 mm.

In operation the device can be hung on a wall or used on a level surface. With one light illuminated the user places his forehead on the pad 9. Diffused light emitted from the LED converges on to the user's face primary in the region of the intended eye. The viewing eye will tend to focus on the illuminated image of the intended eye which is reflected from a point on the reflective surface halfway between both eyes. This angle of reflection rotates the viewing eye slightly in the direction of the intended eye. This determines the angle at which the visual direction of the intended eye can be seen by the viewing eye. Furthermore, it also determines that the visual direction of the optical system of the intended eye is facing outside the boundary of the reflective surface. The mirror may be made of any solid material that produces a mirror-like surface that will effectively maintain the curvatures described above. The device can be made small and light enough to be conveniently carried about the person. Ordinary or rechargeable batteries may be employed as an internal source of electricity and stored in compartments on each side of the box compartments (FIG. 2, item 12).

1. An optical device comprising a toroidal reflective surface element suitable for use in providing an on axis view of either eye of the user herein referred to as said one eye when viewed from a radially displaced position such that visible information at said radially displaced position is presented to either said one eye or the other eye in an on axis position without being obscured by any light obstructing means.

2. (canceled)

3. An optical device as claimed in claim 1 wherein said radially displaced position is the position of the other eye of the user.

4. An optical device as claimed in claim 1 wherein the average radius of maximum curvature of said reflective surface is between 70 mm and 120 mm.

5. An optical device as claimed in claim 1 wherein the average radius of minimum curvature of said reflective surface is between 130 mm and 180 mm.

6. An optical device as claimed in claim 1 wherein the average radius of maximum curvature is between 90 mm and 110 mm.

7. An optical device as claimed in claim 1 and wherein radius of minimum curvature is between 150 mm and 170 mm wherein the eye to eye radial spacing of said axes is between 50 mm and 70 mm.

8. An optical device as claimed in claim 1 wherein the device incorporates one or more light sources.

9. (canceled)

10. A device for providing an on axis view of either eye of a user, herein referred to as said one eye, comprising:
an optical device comprising a toroidal reflective surface element, such that visible information when viewed from a radially displaced position is presented to either said one eye or either eye in an on axis position without being obscured by any light obstructing means.

11. A device as claimed in claim 10 wherein said radially displaced position is the position of the other eye of the user.

12. A device as claimed in claim 10 wherein the average radius of maximum curvature of said reflective surface of the optical device is between 70 mm and 120 mm.

13. A device as claimed in claim 10 wherein the average radius of minimum curvature of said reflective surface of the optical device is between 130 mm and 180 mm.

14. A device a claimed in claim 10 wherein the average radius of maximum curvature of said reflective surface of the optical device is between 90 mm and 110 mm.

15. A device as claimed in claim 10 wherein the radius of minimum curvature of said reflective surface of the optical device is between 150 mm and 170 mm wherein the eye to eye radial spacing of said axes is between 50 mm and 70 mm.

16. A device as claimed in claim 10 wherein the device incorporates one or more light sources.
